(19) United States
(12) Patent Application Publication
(10) Pub. No.: US 2020/0319424 A1
(43) Pub. Date: Oct. 8, 2020

(54) OPTICAL LENS, LENS MODULE, AND ELECTRONIC DEVICE

(71) Applicant: HON HAI PRECISION INDUSTRY CO., LTD., New Taipei (TW)

(72) Inventors: YA-LAN FENG, New Taipei (TW); CHUN-CHENG KO, New Taipei (TW)

(21) Appl. No.: 16/729,073

(22) Filed: Dec. 27, 2019

(30) Foreign Application Priority Data
Apr. 8, 2019 (CN) 201910275110.1

(51) Int. Cl. G02B 7/02

(52) U.S. Cl. CPC G02B 7/021; G02B 13/18

(57) ABSTRACT

An optical lens includes a lens barrel and a lens group received in the lens barrel. The lens group includes a number of lenses stacked from an image side to an object side. Each of the lenses includes a first surface and a second surface coupled to the first surface. The first surface faces the object side. The second surface is parallel to an optical axis of the lens group. The first surface includes a connection region adjacent to the second surface. The connection region includes an optical microstructure. An included angle formed between the image side of the connection region and the second surface of at least one of the lenses is less than 15 degrees.

### FIELD

The subject matter herein generally relates to optical lenses, and more particularly to an optical lens having an improved imaging effect.

### BACKGROUND

At present, manufacture of optical lenses requires ultra-precision processing to process a portion of an original textured surface into a glossy surface. However, a curvature of a lathing tool easily leads to excessive processing at an interface between the glossy surface and the textured surface, and thereby produces a glossy surface at the interface. Thus, light is reflected on the glossy surface of the interface, which forms stray light and affects an imaging quality of the optical lens.

### BRIEF DESCRIPTION OF THE DRAWINGS

Implementations of the present disclosure will now be described, by way of embodiments, with reference to the attached figures.

FIG. 1 is an assembled, isometric view of an embodiment of an optical lens.

FIG. 2 is an exploded, isometric view of the optical lens in FIG. 1.

FIG. 3 is similar to FIG. 2, but showing the optical lens from another angle.

FIG. 4 is an isometric view of a first lens of the optical lens.

FIG. 5 is a cross-sectional view taken along line V-V in FIG. 1.

FIG. 6 is an isometric view of an embodiment of an electronic device including a lens module.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or other word that “substantially” modifies, such that the component need not be exact. For example, “substantially cylindrical” means that the object resembles a cylinder, but can have one or more deviations from a true cylinder. The term “comprising” means “including, but not necessarily limited to”; it specifically indicates open-ended inclusion or membership in a so-described combination, group, series and the like.

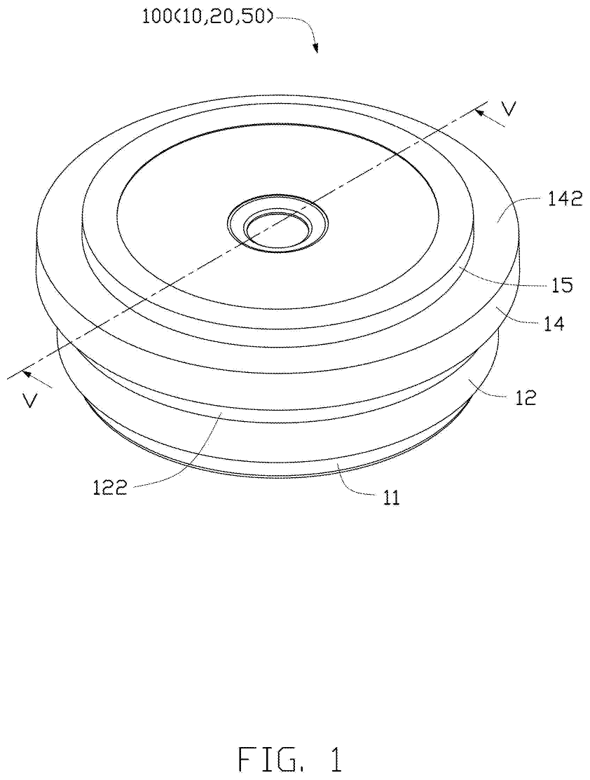

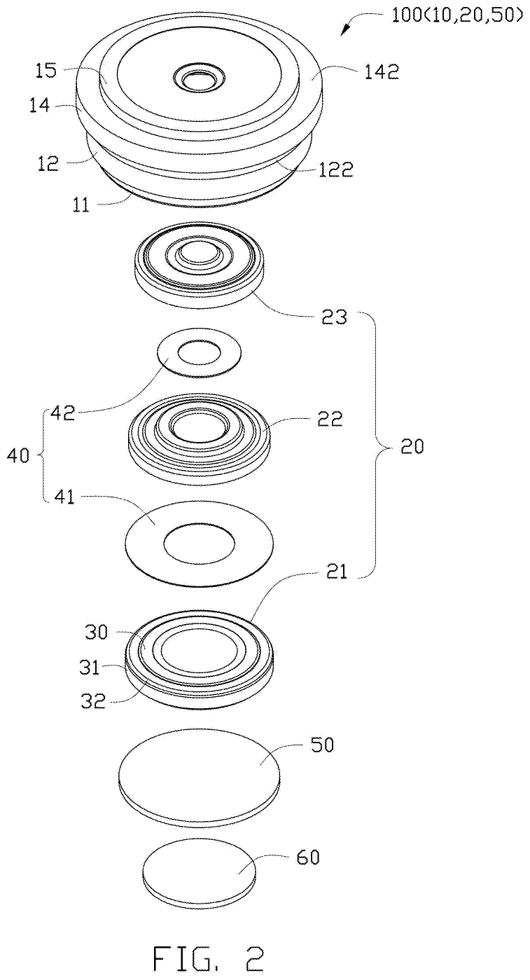

FIGS. 1 and 2 show an embodiment of an optical lens 100. The optical lens 100 includes a lens barrel 10, a lens group 20, and a filter 50.

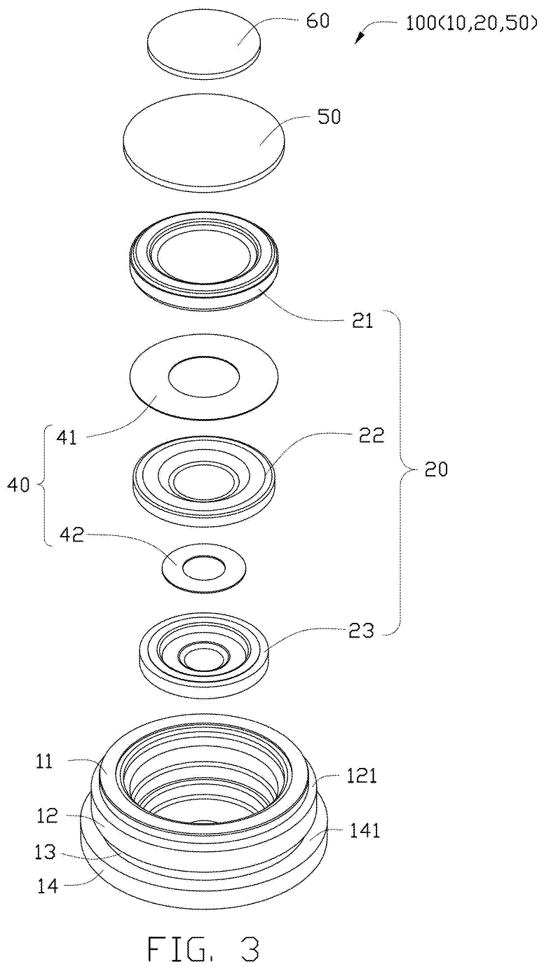

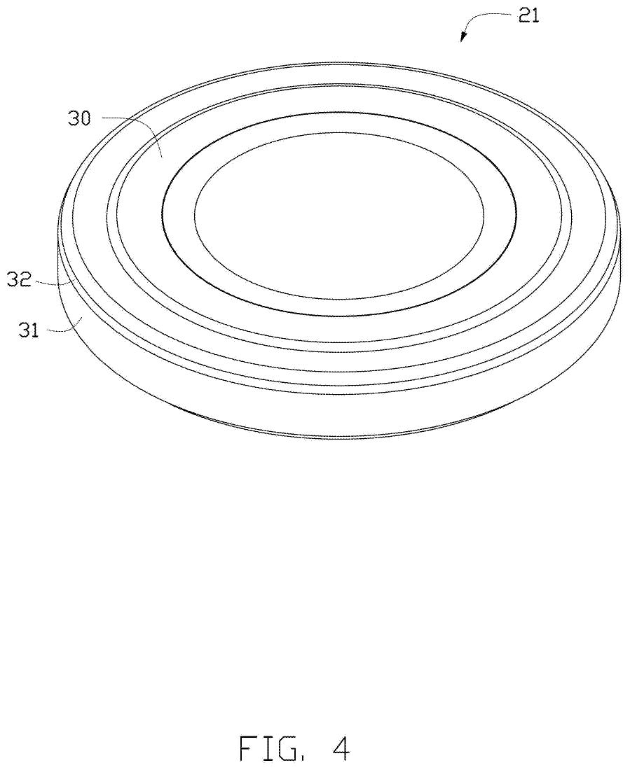

Referring to FIGS. 2-5, the lens barrel 10 is a substantially stepped hollow structure. Specifically, the lens barrel 10 includes a first barrel portion 11, a second barrel portion 12, a third barrel portion 13, a fourth barrel portion 14, and a fifth barrel portion 15. The second barrel portion 12 is connected between the first barrel portion 11 and the third barrel portion 13. The fourth barrel portion 14 is connected between the third barrel portion 13 and the fifth barrel portion 15. A diameter of the second barrel portion 12 is larger than a diameter of the first barrel portion 11 and a diameter of the third barrel portion 13, so that the second barrel portion 12 and the first barrel portion 11 cooperatively form a first step 121, and the second barrel portion 12 and the third barrel portion 13 cooperatively form a second step 122. A diameter of the fourth barrel portion 14 is larger than the diameter of the third barrel portion 13 and a diameter of the fifth barrel portion 15, so that the fourth barrel portion 14 and the third barrel portion 13 cooperatively form a third step 141, and the fourth barrel portion 14 and the fifth barrel portion 15 cooperatively form a fourth step 142. In one embodiment, the diameter of the second barrel portion 12 is less than the diameter of the fourth barrel portion 14. The first barrel portion 11, the second barrel portion 12, the third barrel portion 13, the fourth barrel portion 14, and the first barrel portion 11 may be separately formed and assembled together or may be integrally formed. In one embodiment, the first barrel portion 11, the second barrel portion 12, the third barrel portion 13, the fourth barrel portion 14, and the fifth barrel portion 15 are integrally formed and are made of metal or plastic. In one embodiment, the lens barrel 10 is made of an aluminum alloy.

The lens group 20 is received in the lens barrel 10 along an axial direction of the lens barrel 10. In one embodiment, the lens group 20 includes a first lens 21, a second lens 22, and a third lens 23 stacked in sequence from the image side to an object side. The first lens 21 is housed in the second barrel portion 12. The second lens 22 is partially housed in the second barrel portion 12, partially housed in the third barrel portion 13, and partially housed in the fourth barrel portion 14. The third lens 23 is partially housed in the fourth barrel portion 14 and partially housed in the fifth barrel portion 15.

The first lens 21, the second lens 22, and the third lens 23 may be optical resins having high light transmittance. A light transmittance of the first lens 21, the second lens 22, and the third lens 23 is determined by specific materials of the first lens 21, the second lens 22, and the third lens 23.

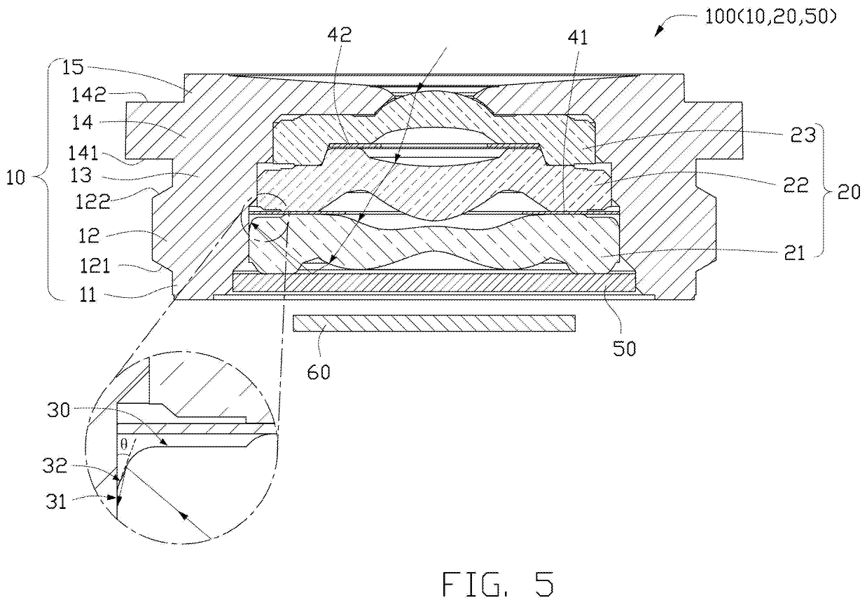

As shown in FIG. 5, each of the first lens 21, the second lens 22, and the third lens 23 includes a first surface 30 and a second surface 31 connected to the first surface 30, such that the first surface 30 faces the object side. The lens group 20 has an optical axis (not shown), and the second surface 31 is substantially parallel to the optical axis of the lens group 20. The first surface 30 includes a connection region 32 near the second surface 31. The connection region 32 includes an optical microstructure. The optical microstructure may be a protrusion, a groove, or other textured structure, which is used to diffusely reflect light. An included angle θ formed between the connection region 32 and the second surface 31 of the first lens 21, the second lens 22, and the third surface 23 is less than 15 degrees. In one embodiment, the included angle θ is 10 degrees. When the included angle θ formed between the connection region 32 and the second surface 31 is less than 15 degrees, the connection region 32 can cover a curvature of a lathing tool to avoid excessive processing and forming a glossy surface of the connection region 32 during manufacture. Thus, the connection region 32 can still diffusely reflect light through the optical microstructure provided thereon and reduce formation of stray light, thereby improving an optical quality of the optical lens 100.

In one embodiment, the optical lens 100 further includes a spacer group 40. The spacer group 40 is housed in the lens barrel 10. The spacer group 40 includes a first spacer 41 and a second spacer 42. The first spacer 41 is located between the first lens 21 and the second lens 22 and is housed in the second barrel portion 12. The second spacer 42 is located between the second lens 22 and the third lens 23 and is housed in the fourth barrel portion 14.

Specifically, the first lens 21, the second lens 22, and the third lens 23 each include an optical portion (not labelled) and a skirt structure (not labelled) surrounding the optical portion and protruding from the optical portion. The first spacer 41 is located between the optical portion of the first lens 21 and the optical portion of the second lens 22, and is surrounded and positioned by the skirt structure of the second lens 22. The second spacer 42 is located between the optical portion of the second lens 22 and the optical portion of the third lens 23, and is surrounded and positioned by the skirt structure of the third lens 23. Both the first spacer 41 and the second spacer 42 are substantially hollow rings. In one embodiment, the first spacer 41 and the second spacer 42 are both light shielding sheets for shielding stray light.

The filter 50 is housed in the first barrel portion 11 and located on a side of the first lens 21 away from the second lens 22. The filter 50 is configured to filter out a portion of light having a specific wavelength band from external light incident on the optical lens 100. The filter 50 may be made of plastic or glass having a specific dye added. The filter 50 may be circular, square, or other shapes. In one embodiment, the filter 50 is circular.

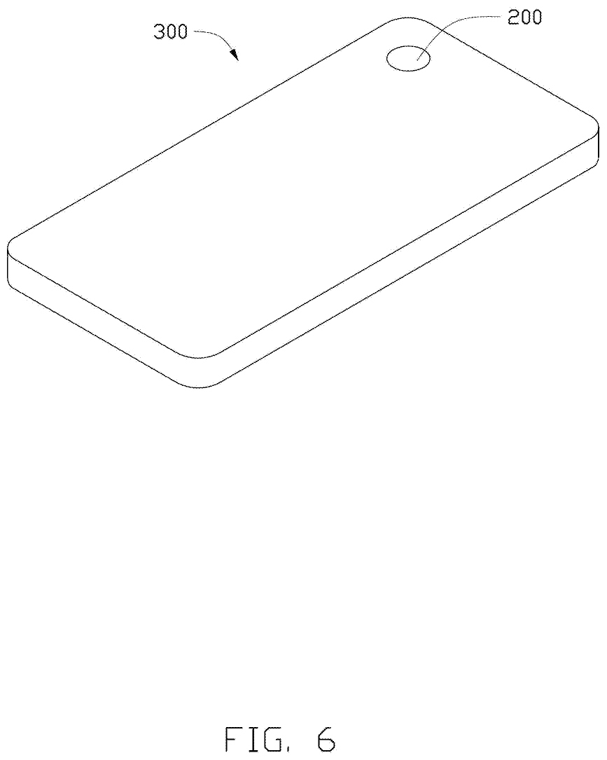

Referring to FIG. 6, the optical lens 100 is applied in a lens module 200. The lens module 200 includes an image sensor 60 (shown in FIG. 5). The image sensor 60 is located outside the lens barrel 10 on a side of the first barrel portion 11 away from the second barrel portion 12. The image sensor 60 is configured to receive light emitted from the filter 50 to form an image. The image sensor 60 may be circular, square, or other shapes. In one embodiment, the image sensor 60 is circular.

Referring to FIG. 6, the lens module 200 can be applied to an electronic device 300, such as a mobile phone, a wearable device, a personal computer, a television, a vehicle, or a monitoring device. In one embodiment, the electronic device 300 is a mobile phone.

The optical lens 100 has the following beneficial effects: if the angle θ formed between the connection region 32 and the second surface 31 is less than 15 degrees, the connection region 32 can cover the curvature of the lathing tool to avoid excessive processing and forming a glossy surface on the connection region 32 during manufacture, so that the connection region 32 can still diffusely reflect the light through the optical microstructure provided thereon, thereby reducing formation of stray light. Furthermore, an optical quality of the optical lens 100 is improved.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. An optical lens comprising:
a lens barrel; and
a lens group received in the lens barrel, the lens group comprising a plurality of lenses stacked from an image side to an object side; wherein:
each of the plurality of lenses comprises a first surface and a second surface coupled to the first surface;
the first surface faces the object side;
the second surface is parallel to an optical axis of the lens group;
the first surface comprises a connection region adjacent to the second surface;
the connection region comprises an optical microstructure;
an included angle formed between the image side of the connection region and the second surface of at least one of the plurality of lenses is less than 15 degrees.

2. The optical lens of claim 1, wherein:
the plurality of lenses of the lens group comprises a first lens, a second lens, and a third lens in said order;
the first lens is located on the image side;
the included angle formed between the connection region and the second surface of each of the first lens, the second lens, and the third lens is less than 15 degrees.

3. The optical lens of claim 2, wherein:
the lens barrel comprises a first barrel portion, a second barrel portion, a third barrel portion, a fourth barrel portion, and a fifth barrel portion;
the second barrel portion is coupled between the first barrel portion and the third barrel portion;
the fourth barrel portion is coupled between the third barrel portion and the fifth barrel portion;
a diameter of the second barrel portion is larger than each of a diameter of the first barrel portion and a diameter of the third barrel portion;
a diameter of the fourth barrel portion is larger than each of the diameter of the third barrel portion and a diameter of the fifth barrel portion;
the diameter of the second barrel portion is less than the diameter of the fourth barrel portion.

4. The optical lens of claim 3, wherein:
the first lens is housed in the second barrel portion;
the second lens is partially housed in the second barrel portion, partially housed in the third barrel portion, and partially housed in the fourth barrel portion; and
the third lens is partially housed in the fourth barrel portion and partially housed in the fifth barrel portion.

5. The optical lens of claim 3, further comprising a spacer group received in the lens barrel, wherein:
the spacer group comprises a first spacer and a second spacer;
the first spacer is located between the first lens and the second lens and is housed in the second barrel portion;
the second spacer is located between the second lens and the third lens and is housed in the fourth barrel portion.

6. The optical lens of claim 3, further comprising a filter housed in the first barrel portion, wherein:
the filter is located on a side of the first lens away from the second lens.

7. A lens module comprising:
an image sensor; and
an optical lens comprising:
a lens barrel; and
a lens group received in the lens barrel, the lens group comprising a plurality of lenses stacked from an image side to an object side; wherein:
each of the plurality of lenses comprises a first surface and a second surface coupled to the first surface;
the first surface faces the object side;
the second surface is parallel to an optical axis of the lens group;
the first surface comprises a connection region adjacent to the second surface;
the connection region comprises an optical microstructure;
an included angle formed between the image side of the connection region and the second surface of at least one of the plurality of lenses is less than 15 degrees; and
the image sensor is located outside the lens barrel on a side of the first barrel portion away from the second barrel portion.

8. The lens module of claim 7, wherein:
the plurality of lenses of the lens group comprises a first lens, a second lens, and a third lens in said order;
the first lens is located on the image side;
the included angle formed between the connection region and the second surface of each of the first lens, the second lens, and the third lens is less than 15 degrees.

9. The lens module of claim 8, wherein:
the lens barrel comprises a first barrel portion, a second barrel portion, a third barrel portion, a fourth barrel portion, and a fifth barrel portion;
the second barrel portion is coupled between the first barrel portion and the third barrel portion;
the fourth barrel portion is coupled between the third barrel portion and the fifth barrel portion;
a diameter of the second barrel portion is larger than each of a diameter of the first barrel portion and a diameter of the third barrel portion;
a diameter of the fourth barrel portion is larger than each of the diameter of the third barrel portion and a diameter of the fifth barrel portion;
the diameter of the second barrel portion is less than the diameter of the fourth barrel portion.

10. The lens module of claim 9, wherein:
the first lens is housed in the second barrel portion;
the second lens is partially housed in the second barrel portion, partially housed in the third barrel portion, and partially housed in the fourth barrel portion; and
the third lens is partially housed in the fourth barrel portion and partially housed in the fifth barrel portion.

11. The lens module of claim 9, wherein:
the optical lens further comprises a spacer group received in the lens barrel;
the spacer group comprises a first spacer and a second spacer;
the first spacer is located between the first lens and the second lens and is housed in the second barrel portion;
the second spacer is located between the second lens and the third lens and is housed in the fourth barrel portion.

12. The lens module of claim 9, wherein:
the optical lens further comprises a filter housed in the first barrel portion; and
the filter is located on a side of the first lens away from the second lens.

13. An electronic device comprising a lens module, the lens module comprising:
an image sensor; and
an optical lens comprising:
a lens barrel; and
a lens group received in the lens barrel, the lens group comprising a plurality of lenses stacked from an image side to an object side; wherein:
each of the plurality of lenses comprises a first surface and a second surface coupled to the first surface;
the first surface faces the object side;
the second surface is parallel to an optical axis of the lens group;
the first surface comprises a connection region adjacent to the second surface;
the connection region comprises an optical microstructure;
an included angle formed between the image side of the connection region and the second surface of at least one of the plurality of lenses is less than 15 degrees; and
the image sensor is located outside the lens barrel on a side of the first barrel portion away from the second barrel portion.

14. The electronic device of claim 13, wherein:
the plurality of lenses of the lens group comprises a first lens, a second lens, and a third lens in said order;
the first lens is located on the image side;
the included angle formed between the connection region and the second surface of each of the first lens, the second lens, and the third lens is less than 15 degrees.

15. The electronic device of claim 14, wherein:
the lens barrel comprises a first barrel portion, a second barrel portion, a third barrel portion, a fourth barrel portion, and a fifth barrel portion;
the second barrel portion is coupled between the first barrel portion and the third barrel portion;
the fourth barrel portion is coupled between the third barrel portion and the fifth barrel portion;
a diameter of the second barrel portion is larger than each of a diameter of the first barrel portion and a diameter of the third barrel portion;
a diameter of the fourth barrel portion is larger than each of the diameter of the third barrel portion and a diameter of the fifth barrel portion;
the diameter of the second barrel portion is less than the diameter of the fourth barrel portion.

16. The electronic device of claim 15, wherein:
the first lens is housed in the second barrel portion;
the second lens is partially housed in the second barrel portion, partially housed in the third barrel portion, and partially housed in the fourth barrel portion; and
the third lens is partially housed in the fourth barrel portion and partially housed in the fifth barrel portion.

17. The electronic device of claim 15, wherein:
the optical lens further comprises a spacer group received in the lens barrel;
the spacer group comprises a first spacer and a second spacer;
the first spacer is located between the first lens and the second lens and is housed in the second barrel portion;
the second spacer is located between the second lens and the third lens and is housed in the fourth barrel portion.

18. The electronic device of claim 15, wherein:
the optical lens further comprises a filter housed in the first barrel portion; and
the filter is located on a side of the first lens away from the second lens.
